(19) United States
(12) Patent Application Publication
(10) Pub. No.: US 2026/0063848 A1
(43) Pub. Date: Mar. 5, 2026

(54) OPTICAL WAVEGUIDE COMPONENT, HOLDING MEMBER, AND OPTICAL CONNECTION MEMBER

(71) Applicant: SUMITOMO ELECTRIC INDUSTRIES, LTD., Osaka (JP)

(72) Inventor: Takuya ISHIDA, Osaka (JP)

(73) Assignee: SUMITOMO ELECTRIC INDUSTRIES, LTD., Osaka (JP)

(21) Appl. No.: 19/316,243

(22) Filed: Sep. 2, 2025

(30) Foreign Application Priority Data
Sep. 4, 2024 (JP) 2024-152359

(51) Int. Cl. G02B 6/30

(52) U.S. Cl. CPC G02B 6/30

(57) ABSTRACT

An optical waveguide component includes a base member, and a plurality of optical waveguides extending in a first direction inside the base member and being arranged in a second direction intersecting the first direction. Each of the plurality of optical waveguides has a pair of end portions. The base member includes a positioning structure configured to position the base member and has a surface at which the pairs of end portions are exposed. Each of the plurality of optical waveguides includes a curved portion curved in the second direction. The positioning structure is disposed at a position overlapping with the curved portions in the second direction.

### CROSS REFERENCE TO RELATED APPLICATIONS

This application claims priority based on Japanese Patent Application No. 2024-152359 filed on Sep. 4, 2024, and the entire contents of the Japanese patent application are incorporated herein by reference.

### TECHNICAL FIELD

The present disclosure relates to an optical waveguide component, a holding member, and an optical connection member.

### BACKGROUND

An optical waveguide component including an optical waveguide is known (Patent literature 1: WO 2020/059639). Patent literature 1 discloses an optical connection member including an optical waveguide component. The optical waveguide component includes a plurality of optical waveguides arranged in a predetermined direction, and has a surface at which an end portion of each of the plurality of optical waveguides is exposed.

### SUMMARY

An optical waveguide component according to an embodiment of the present disclosure includes a base member, and a plurality of optical waveguides extending in a first direction inside the base member and being arranged in a second direction intersecting the first direction. Each of the plurality of optical waveguides has a pair of end portions. The base member includes a positioning structure configured to position the base member and has a surface at which the pairs of end portions are exposed. Each of the plurality of optical waveguides includes a curved portion curved in the second direction. The positioning structure is disposed at a position overlapping with the curved portions in the second direction.

### BRIEF DESCRIPTION OF THE DRAWINGS

FIG. 1 is a perspective view showing an optical connection member of an embodiment.

FIG. 2 is a perspective view showing a portion of an optical connection member.

FIG. 3A is a diagram showing an optical waveguide component and FIG. 3B is a diagram showing a holding member.

FIG. 4 is a schematic perspective view showing the optical waveguide component.

FIG. 5 is a plan view showing the optical waveguide component in the embodiment.

FIG. 6 is a plan view showing an optical waveguide component in a modification of the embodiment.

FIG. 7 is a plan view and a side surface view showing the optical waveguide component in the modification of the embodiment.

### DETAILED DESCRIPTION

In positioning of the optical waveguide component, when a positioning structure is provided in the optical waveguide component, the positioning structure may interfere with the optical waveguide. In order to avoid interference between the positioning structure and the optical waveguide, it is conceivable to maintain a distance between the positioning structure and the optical waveguide. However, when the distance between the positioning structure and the optical waveguide is maintained, the optical waveguide component is prevented from being miniaturized in order to maintain the arrangement space of the positioning structure.

An object of the present disclosure is to provide a compact optical waveguide component having a positioning structure, a compact holding member in which the optical waveguide component is more reliably positioned, and a compact optical connection member in which the optical waveguide component is easily positioned.

### Description of Embodiments of Present Disclosure

First, the contents of the embodiments of the present disclosure will be listed and described.

(1) An optical waveguide component according to an embodiment of the present disclosure includes a base member, and a plurality of optical waveguides extending in a first direction inside the base member and being arranged in a second direction intersecting the first direction. Each of the plurality of optical waveguides has a pair of end portions. The base member includes a positioning structure configured to position the base member and has a surface at which the pairs of end portions are exposed. Each of the plurality of optical waveguides includes a curved portion curved in the second direction. The positioning structure is disposed at a position overlapping with the curved portions in the second direction.

In this optical waveguide component, the positioning structure is disposed at a position overlapping with the curved portion of the optical waveguide. In this case, the positioning structure is disposed in the space maintained by the curved portion. Thus, a compact optical waveguide component is provided, in which interference between the positioning structure and the optical waveguide is avoided.

(2) In the optical waveguide component of the above (1), the surface may include a first end surface at which first end portions among the pairs of end portions of the plurality of optical waveguides are exposed and a second end surface at which second end portions among the pairs of end portions of the plurality of optical waveguides are exposed, the second end surface being located opposite to the first end surface in the first direction. An arrangement order of the plurality of optical waveguides exposed at the first end surface may be identical to an arrangement order of the plurality of optical waveguides exposed at the second end surface. In this case, the input to the optical waveguide component and the output from the optical waveguide component are identical. Thus, a compact optical waveguide component with identical input and output is provided without interference between the positioning structure and the optical waveguide.

(3) In the optical waveguide component according to the above (1) or (2), a shortest distance between each of the optical waveguides and the positioning structure may be less than 1 mm. In this case, a compact optical waveguide component provided with a positioning structure is provided.

(4) The optical waveguide component of any one of the above (1) to (3), the optical waveguide component may have a pair of side surfaces arranged in the second direction. The positioning structure may have a shape in which at least one of the side surfaces is recessed in the second direction. A compact optical waveguide component that can be easily positioned is provided.

(5) A holding member according to another embodiment of the present disclosure includes an engagement portion configured to engage the positioning structure of the optical waveguide component according to any one of the above (1) to (4). The holding member is provided that has a compact configuration and more reliably positions the optical waveguide component.

(6) An optical connection member according to still another embodiment of the present disclosure includes the optical waveguide component according to any one of the above (1) to (4), a holding member including an engagement portion configured to engage the positioning structure of the optical waveguide component, and a plurality of optical fibers connected to the optical waveguide component. An optical waveguide component that can be easily positioned in a compact configuration is provided.

### Details of Embodiments of Present Disclosure

Specific examples of the present disclosure are described below with reference to the drawings. The present disclosure is not limited to the examples, but is defined by the scope of the claims, and is intended to include all modifications within the meaning and scope equivalent to the scope of the claims. In the following description, the same elements are denoted by the same reference numerals in the description of the drawings, and redundant description will be omitted.

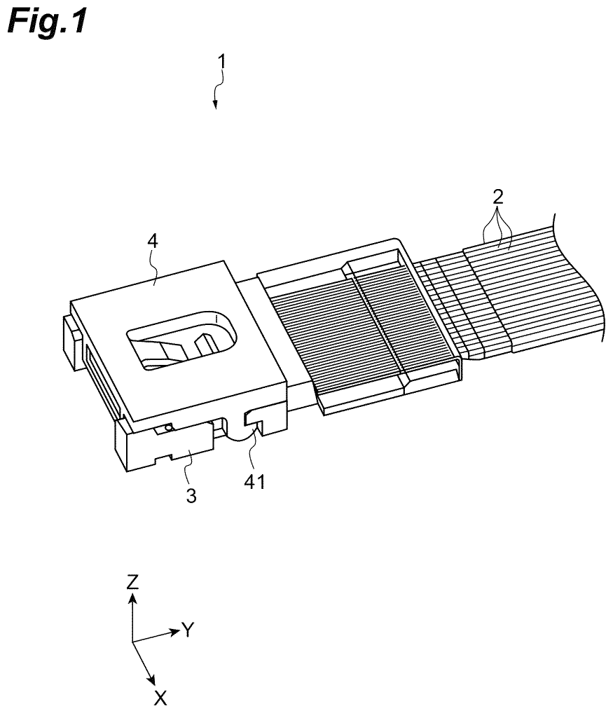

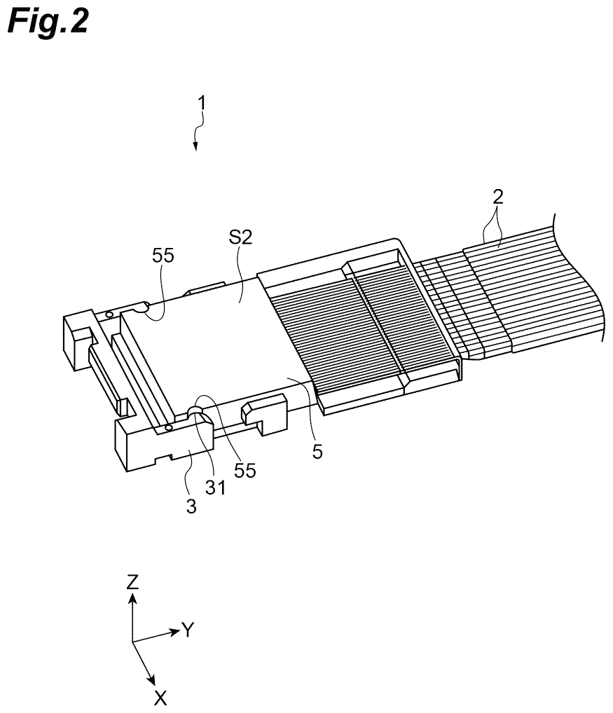

FIG. 1 is a perspective view showing an optical connection member according to an embodiment of the present disclosure. FIG. 2 is a perspective view showing a part of the optical connection member. In these drawings, an XYZ orthogonal coordinate system is shown for easy understanding.

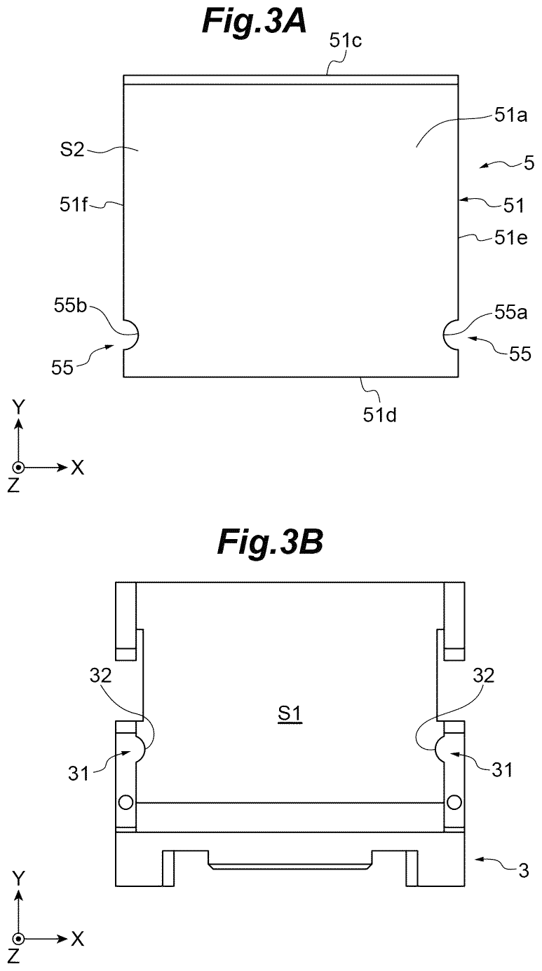

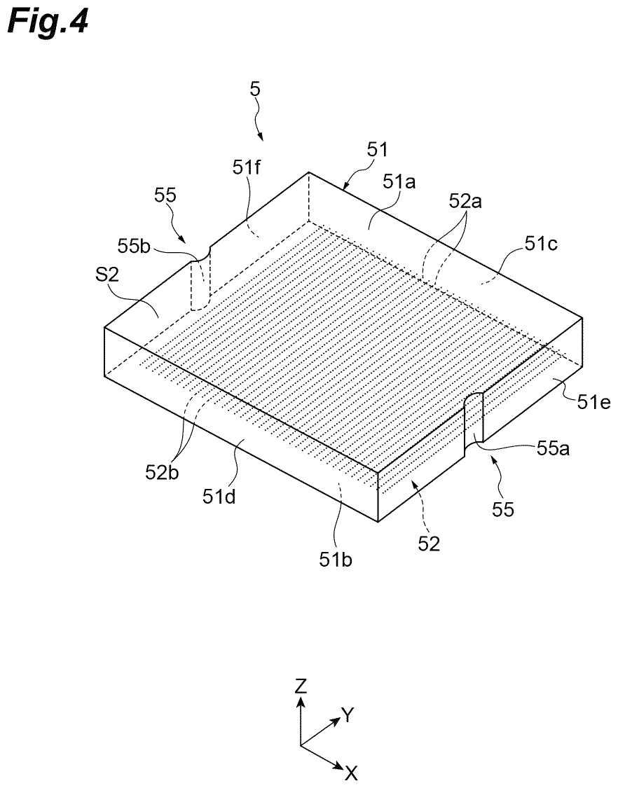

An optical connection member 1 is connected to a device. For example, the optical connection member 1 is connected to a silicon photonics chip. The optical connection member 1 includes, for example, a plurality of optical fibers 2, a holding member 3, a lid 4, and an optical waveguide component 5. FIG. 3A is a diagram showing an optical waveguide component, and FIG. 3B is a diagram showing a holding member. FIG. 4 is a schematic perspective view showing an optical waveguide component.

The plurality of optical fibers 2 are optically connected to the optical waveguide component 5. The plurality of optical fibers 2 are optically connected to the optical waveguide of the silicon photonics chip through the optical waveguide component 5. Each optical fiber 2 is, for example, a single-mode optical fiber. The mode field diameter of the optical fiber 2 is larger than the mode field diameter of the optical waveguide of the silicon photonics chip, for example. The refractive index of the core of the optical fiber 2 is smaller than the refractive index of the optical waveguide of the silicon photonics chip, for example.

The holding member 3 holds the optical waveguide component 5. The holding member 3 positions the optical waveguide component 5 on the silicon photonics chip, for example. The holding member 3 is fixed to the silicon photonics chip with, for example, an adhesive. The holding member 3 is provided with an engagement portion 31 as shown in FIG. 2 and FIG. 3B. The engagement portion 31 engages with the optical waveguide component 5. The holding member 3 has, for example, an internal space S1 in which the optical waveguide component 5 is disposed.

The engagement portion 31 includes a pair of protrusions 32 protruding toward the internal space S1 in the X-axis direction. The pair of protrusions 32 face each other in the X-axis direction, for example. One protrusion 32 protrudes toward the other protrusion 32. Each protrusion 32 protrudes, for example, toward the optical waveguide component 5. The optical waveguide component 5 is sandwiched between the pair of protrusions 32, for example.

The lid 4 is fixed to the holding member 3. For example, the lid 4 includes a claw portion 41 configured to engage with the holding member 3. For example, the claw portion 41 is engaged with the holding member 3 as shown in FIG. 1 and fixed to the holding member 3. The lid 4 fixes the optical waveguide component 5 to the holding member 3 in the Z-axis direction.

The optical waveguide component 5 is optically connected to the plurality of optical fibers 2. The optical waveguide component 5 is used to convert, for example, a mode field diameter. The optical waveguide component 5 suitably converts the mode field diameter and the refractive index difference between the optical fiber 2 and the silicon photonics chip, and thus the optical loss is reduced. The optical waveguide component 5 guides light from the plurality of optical fibers 2 to an optical waveguide of the silicon photonics chip, for example. The optical waveguide component 5 includes a base member 51 and a plurality of optical waveguides 52.

The base member 51 has a surface S2 to which the plurality of optical waveguides 52 are exposed. As shown in FIG. 4, the surface S2 includes a pair of main surfaces 51a and 51b, a pair of end surfaces 51c and 51d, and a pair of side surfaces 51e and 51f. The pair of main surfaces 51a and 51b, the pair of end surfaces 51c and 51d, and the pair of side surfaces 51e and 51f are, for example, flat surfaces and rectangular. The base member 51 has, for example, a substantially rectangular parallelepiped shape. The base member 51 is made of, for example, glass. The material of the base member 51 is, for example, quartz glass, alkali-free glass (for example, EAGLE XG (registered trademark)), or borosilicate glass (for example, TEMPAX Float (registered trademark)).

The pair of main surfaces 51a and 51b are along the X-axis direction and the Y-axis direction, and face each other in the Z-axis direction. One of the pair of main surfaces 51a and 51b is located on the opposite side of the other in the Z-axis direction. The pair of main surfaces 51a and 51b are arranged in the Z-axis direction, and may be parallel to each other or inclined to each other. The pair of end surfaces 51c and 51d are along the X-axis direction and the Z-axis direction, and face each other in the Y-axis direction. One of the pair of end surfaces 51c and 51d is located on the opposite side of the other in the Y-axis direction. The pair of end surfaces 51c and 51d are arranged in the Y-axis direction, and may be parallel to each other or inclined to each other. The pair of side surfaces 51e and 51f are along the Y-axis direction and the Z-axis direction, and face each other in the X-axis direction. One of the pair of side surfaces 51e and 51f is located on the opposite side of the other in the X-axis direction. The pair of side surfaces 51e and 51f are arranged in the X-axis direction, and may be parallel to each other or inclined to each other.

The plurality of optical waveguides 52 are cores formed inside the base member 51. The plurality of optical waveguides 52 include at least two or more optical waveguides. The optical waveguide 52 extends in the Y-axis direction and propagates light in that direction. The plurality of optical waveguides 52 extend in the Y-axis direction inside the base member 51 and are arranged in a direction intersecting the Y-axis direction. Each of the plurality of optical waveguides 52 has a pair of end portions 52a and 52b. The pair of end portions 52a and 52b include a first end portion 52a and a second end portion 52b opposite to the first end portion 52a. The first end portion 52a is exposed from the end surface 51c of the base member 51. The second end portion 52b is exposed from an end surface 51d of the base member 51. For example, the first end portion 52a is coupled to the optical fiber 2, and the second end portion 52b is coupled to an optical waveguide of the silicon photonics chip.

The optical waveguide 52 may guide light from the first end portion 52a to the second end portion 52b, or may guide light from the second end portion 52b to the first end portion 52a. The optical waveguide 52 includes a modified region having a refractive index higher than a refractive index of the base member 51 around the optical waveguide 52. The modified region is a laser processing region formed by condensing and scanning a laser beam having an extremely short time width such as a femtosecond order on the inside of the base member 51 and modifying the glass by multiphoton absorption.

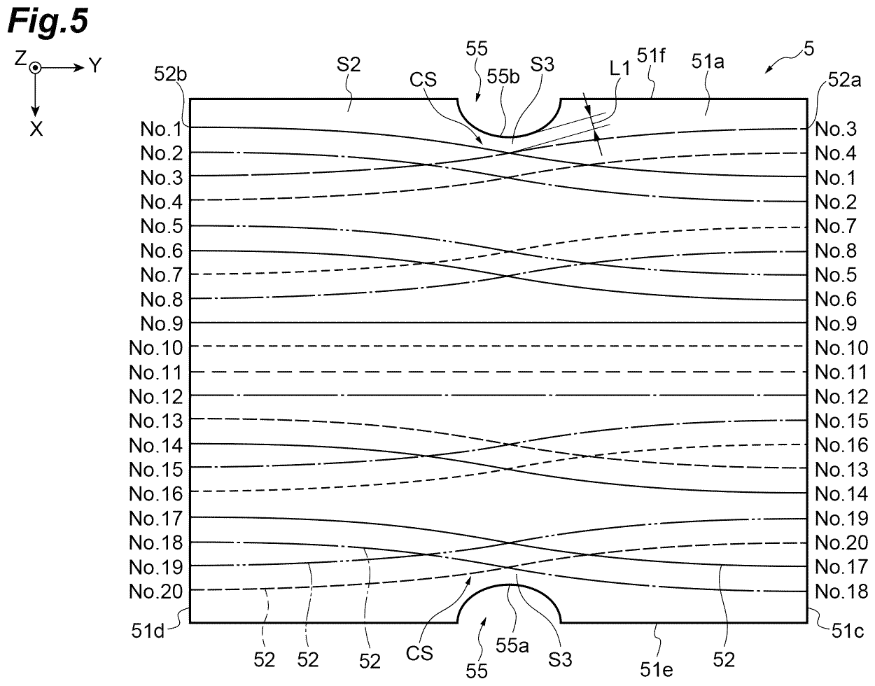

Next, the configuration of the optical waveguide component 5 will be described in more detail. FIG. 5 is a plan view showing the optical waveguide component 5 in the embodiment.

The plurality of optical waveguides 52 include a curved portion CS that is curved in the X-axis direction, as shown in FIG. 5. In FIG. 5, the plurality of optical waveguides 52 are denoted by No. 1 to No. 20. In the example shown in the embodiment, at least a part of the plurality of optical waveguides 52 is curved by the curved portion CS and intersects with another optical waveguide 52 when viewed along the Z-axis direction. In the example shown in the embodiment, the arrangement order of the plurality of optical waveguides 52 exposed at the end surface 51c is different from the arrangement order of the plurality of optical waveguides 52 exposed at the end surface 51d.

The plurality of optical waveguides 52 form a space S3 by the curved portion CS between the surface S2 of the base member 51 and the plurality of optical waveguides 52 when viewed from the Z-axis direction. The space S3 is located at a position overlapping the plurality of optical waveguides 52 in the Y-axis direction. In other words, the space S3 is located at a position overlapping the plurality of optical waveguides 52 when viewed along the Y-axis direction. The width of the entire plurality of optical waveguides 52 in the X-axis direction in the curved portion CS is smaller than the width of the entire plurality of optical waveguides 52 in the X-axis direction in the end surfaces 51c and 51d.

The base member 51 includes a positioning structure 55 for positioning the base member 51. The positioning structure 55 engages with the engagement portion 31 of the holding member 3. The positioning structure 55 is disposed at a position overlapping the curved portion CS in the X-axis direction. The positioning structure 55 is disposed in the space S3. In other words, the space S3 is located at a position overlapping the plurality of optical waveguides 52 when viewed along the Y-axis direction.

The positioning structure 55 is, for example, a recess formed in the surface S2 of the base member 51. The positioning structure 55 has, for example, a shape in which the surface S2 is recessed in the X-axis direction. The positioning structure 55 includes, for example, a pair of recessed portions 55a and 55b provided on each of the side surfaces 51e and 51f. The pair of recessed portions 55a and 55b have a shape recessed in the X-axis direction. The recessed portion 55a is recessed from the side surface 51e toward the curved portion CS. At least a part of the recessed portion 55a is located in the space S3. The recessed portion 55b is recessed from the side surface 51f toward the curved portion CS. At least a part of the recessed portion 55b is located in the space S3. For example, the pair of recessed portions 55a and 55b are located on the identical straight line in the X-axis direction. For example, the recessed portions 55a and 55b have an arc shape when viewed along the Z-axis direction.

In the optical waveguide component 5, a shortest distance L1 between the optical waveguide 52 and the positioning structure 55 is, for example, 0.1 mm or more and less than 1 mm. When the shortest distance L1 between the optical waveguide 52 and the positioning structure 55 is 0.1 mm or more, the leakage of light of the optical waveguide 52 is reduced. When the shortest distance between the optical waveguide 52 and the positioning structure 55 is less than 1 mm, a space for disposing the positioning structure 55 is maintained.

For example, the pair of protrusions 32 of the holding member 3 are respectively fitted into the recessed portions 55a and 55b. In other words, the pair of protrusions 32 of the holding member 3 are inserted into the recessed portions 55a and 55b, respectively.

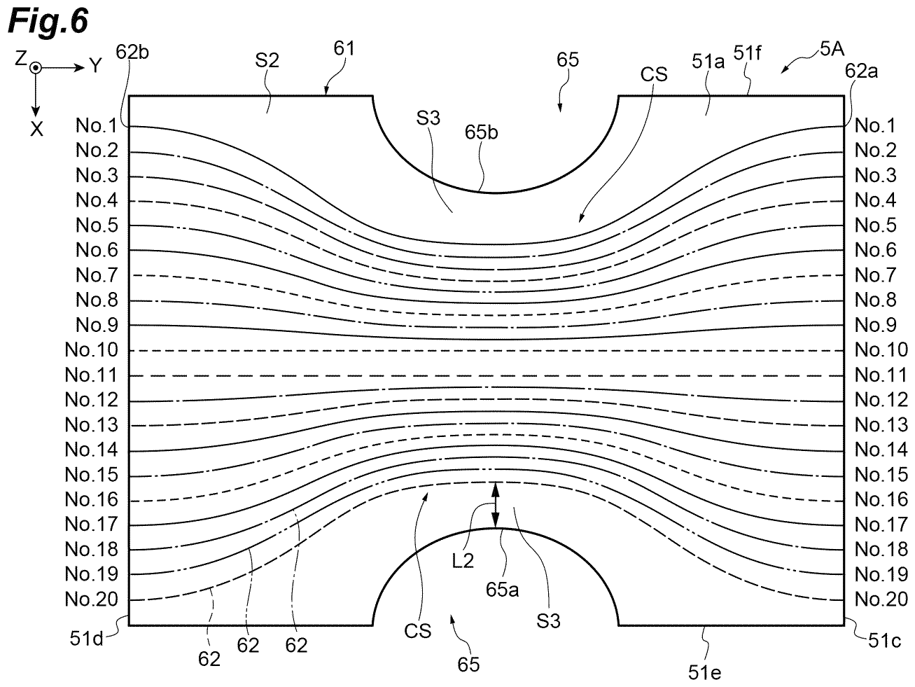

Next, an optical waveguide component 5A in a modification of the embodiment will be described with reference to FIG. 6. FIG. 6 is a plan view showing the optical waveguide component 5A in the modification. The modification is generally similar or identical to the embodiments described above. The modification is different from the above-described embodiment in the configuration of the plurality of optical waveguides and the positioning structure. Hereinafter, the difference between the above-described embodiment and the modification will be mainly described.

The optical waveguide component 5A includes a base member 61 and a plurality of optical waveguides 62. The base member 61 includes a positioning structure 65 for positioning the base member 61 and has an identical configuration to the base member 51, except for the configuration of the positioning structure 65 and the configuration related to the plurality of optical waveguides 62 The positioning structure 65 is different from the positioning structure 55 only in size. For example, the positioning structure 65 includes a pair of recessed portions 65a, 65b similar to the pair of recessed portions 55a, 55b of the positioning structure 55. The pair of recessed portions 65a and 65b have a shape recessed in the X-axis direction.

In the optical waveguide component 5A, a shortest distance L2 between the optical waveguide 62 and the positioning structure 65 is, for example, 0.1 mm or more and less than 1 mm. When the shortest distance L2 between the optical waveguide 62 and the positioning structure 65 is 0.1 mm or more, the leakage of light of the optical waveguide 62 is reduced. When the shortest distance between the optical waveguide 62 and the positioning structure 65 is less than 1 mm, a space for disposing the positioning structure 65 is maintained.

The plurality of optical waveguides 62 are cores formed inside the base member 61. The plurality of optical waveguides 62 include at least two or more optical waveguides. The optical waveguide 62 extends in the Y-axis direction and propagates light in that direction. The plurality of optical waveguides 62 extend in the Y-axis direction inside the base member 61 and are arranged in a direction intersecting the Y-axis direction. Each of the plurality of optical waveguides 62 has a pair of end portions 62a and 62b. The pair of end portions 62a and 62b include a first end portion 62a and a second end portion 62b opposite to the first end portion 62a. The first end portion 62a is exposed from the end surface 51c of the base member 61. The second end portion 62b is exposed from the end surface 51d of the base member 61. For example, the first end portion 62a is coupled to the optical fiber 2, and the second end portion 62b is coupled to an optical waveguide of the silicon photonics chip.

The optical waveguide 62 may guide light from the first end portion 62a to the second end portion 62b, or may guide light from the second end portion 62b to the first end portion 62a. The optical waveguide 62 includes a modified region having a refractive index higher than a refractive index of the base member 61 around the optical waveguide 62.

The plurality of optical waveguides 62 include the curved portion CS that is curved in the X-axis direction, as shown in FIG. 6. In FIG. 6, the plurality of optical waveguides 62 are denoted by No. 1 to No. 20. In the modification, at least a part of the plurality of optical waveguides 62 is curved by the curved portion CS and does not intersect with another optical waveguide 62 when viewed along the Z-axis direction. The arrangement order of the plurality of optical waveguides 62 exposed at the end surface 51c is identical to the arrangement order of the plurality of optical waveguides 62 exposed at the end surface 51d.

The plurality of optical waveguides 62 form the space S3 by the curved portion CS between the surface S2 of the base member 61 and the plurality of optical waveguides 62 when viewed from the Z-axis direction. The space S3 is located at a position overlapping the plurality of optical waveguides 62 in the Y-axis direction. In other words, the space S3 is located at a position overlapping the plurality of optical waveguides 62 when viewed along the Y-axis direction. The width of the entire plurality of optical waveguides 62 in the X-axis direction in the curved portion CS is smaller than the width of the entire plurality of optical waveguides 62 in the X-axis direction in the end surfaces 51c and 51d.

Thus, the space S3 of the optical waveguide component 5A is maintained to be wider than the space S3 of the optical waveguide component 5 without intersecting the plurality of optical waveguides 62 when viewed along the Z-axis direction. The ratio of the size of the positioning structure 65 to the size of the base member 61 is maintained to be greater than the ratio of the size of the positioning structure 55 to the size of the base member 51. As a further modification of the modification, the size of the positioning structure 65 may be reduced, and the size of the optical waveguide component 5A may be further reduced.

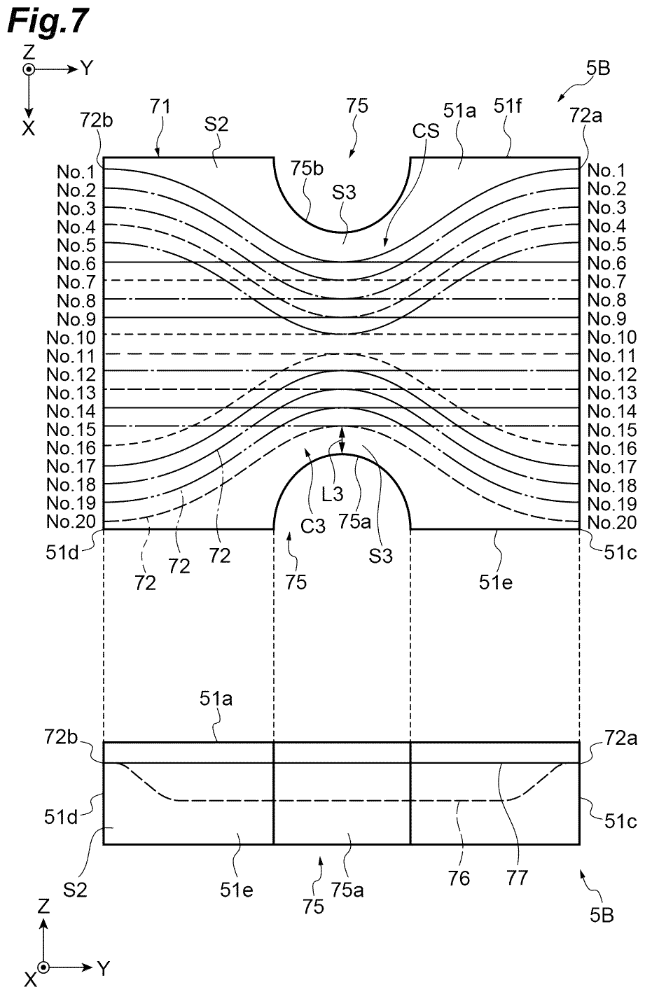

Next, an optical waveguide component 5B in the modification of the embodiment will be described with reference to FIG. 7. FIG. 7 is a plan view showing the optical waveguide component 5B in the modification. The modification is generally similar or identical to the embodiments described above. The modification is different from the above-described embodiment in the configuration of the plurality of optical waveguides and the positioning structure. Hereinafter, the difference between the above-described embodiment and the modification will be mainly described.

The optical waveguide component 5B includes a base member 71 and a plurality of optical waveguides 72. The base member 71 includes a positioning structure 75 for positioning the base member 71, and has an identical configuration to the base member 51 except for the configuration of the positioning structure 75 and the configuration related to the plurality of optical waveguides 72. The positioning structure 75 is different from the positioning structure 55 only in size. For example, the positioning structure 75 includes a pair of recessed portions 75a, 75b similar to the pair of recessed portions 55a, 55b of the positioning structure 55. The pair of recessed portions 75a and 75b have a shape recessed in the X-axis direction.

In the optical waveguide component 5B, a shortest distance L3 between the optical waveguide 72 and the positioning structure 75 is, for example, 0.1 mm or more and less than 1 mm. When the shortest distance L3 between the optical waveguide 72 and the positioning structure 75 is 0.1 mm or more, the leakage of light of the optical waveguide 72 is reduced. When the shortest distance between the optical waveguide 72 and the positioning structure 75 is less than 1 mm, a space for disposing the positioning structure 75 is maintained.

The plurality of optical waveguides 72 are cores formed inside the base member 71. The plurality of optical waveguides 72 include at least two or more optical waveguides. The optical waveguide 72 extends in the Y-axis direction and propagates light in that direction. The plurality of optical waveguides 72 extend in the Y-axis direction inside the base member 71 and are arranged in a direction intersecting the Y-axis direction. Each of the plurality of optical waveguides 72 has a pair of end portions 72a and 72b. The pair of end portions 72a and 72b include a first end portion 72a and a second end portion 72b opposite to the first end portion 72a. The first end portion 72a is exposed from the end surface 51c of the base member 71. The second end portion 72b is exposed from the end surface 51d of the base member 71. For example, the first end portion 72a is coupled to the optical fiber 2, and the second end portion 72b is coupled to an optical waveguide of the silicon photonics chip.

The optical waveguide 72 may guide light from the first end portion 72a to the second end portion 72b, and may guide light from the second end portion 72b to the first end portion 72a. The optical waveguide 72 includes a modified region having a refractive index higher than a refractive index of the base member 71 around the optical waveguide 72.

The plurality of optical waveguides 72 include the curved portion CS that is curved in the X-axis direction, as shown in FIG. 7. In FIG. 7, the plurality of optical waveguides 72 are denoted by No. 1 to No. 20. In the modification, at least a part of the plurality of optical waveguides 72 is curved by the curved portion CS and intersects with another optical waveguide 72 when viewed along the Z-axis direction. The arrangement order of the plurality of optical waveguides 72 exposed at the end surface 51c is identical to the arrangement order of the plurality of optical waveguides 72 exposed at the end surface 51d.

The plurality of optical waveguides 72 are partially composed of a plurality of stages. The plurality of optical waveguides 72 include a plurality of optical waveguides 76 and a plurality of optical waveguides 77. The plurality of optical waveguides 76 and the plurality of optical waveguides 77 are partially located at different heights in the Z-axis direction. The plurality of optical waveguides 76 and the plurality of optical waveguides 77 intersect each other when viewed along the Z-axis direction without interfering with each other.

The plurality of optical waveguides 72 form the space S3 by the curved portion CS between the surface S2 of the base member 71 and the plurality of optical waveguides 72 when viewed from the Z-axis direction. The space S3 is located at a position overlapping the plurality of optical waveguides 72 in the Y-axis direction. In other words, the space S3 is located at a position overlapping the plurality of optical waveguides 72 when viewed along the Y-axis direction. The width of the entire plurality of optical waveguides 72 in the X-axis direction in the curved portion CS is smaller than the width of the entire plurality of optical waveguides 72 in the end surfaces 51c and 51d in the X-axis direction.

Thus, the space S3 of the optical waveguide component 5B is maintained to be wider than the space S3 of the optical waveguide component 5 and the optical waveguide component 5A. The ratio of the size of the positioning structure 75 to the base member 71 is maintained to be larger than the ratio of the size of the positioning structure 55 to the base member 51 and the ratio of the size of the positioning structure 65 to the base member 61. As a further modification of the modification, the size of the positioning structure 75 may be reduced, and the size of the optical waveguide component 5B may be further reduced.

The effects obtained by the optical waveguide components 5, 5A, and 5B of the embodiment described above will be described.

In the optical waveguide component 5, the positioning structure 55 is disposed at a position overlapping the curved portion CS of the optical waveguide 52. In this case, the positioning structure 55 is disposed in the space S3 maintained by the curved portion CS. Thus, the compact optical waveguide component 5 is provided in which interference between the positioning structure 55 and the optical waveguide 52 is avoided. The optical waveguide components 5A and 5B also have the similar configuration to the optical waveguide component 5 in this respect, and the similar effect is exhibited.

In the optical waveguide component 5A, the surface S2 includes the first end surface 51c and the second end surface 51d. At the first end surface 51c, the end portion 62a of the pair of end portions 62a and 62b of the plurality of optical waveguides 62 is exposed. At the second end surface 51d, the end portion 62b of the pair of end portions 62a and 62b of the plurality of optical waveguides 62 is exposed and is located on the opposite side of the first end surface 51c in the Y-axis direction. The arrangement order of the plurality of optical waveguides 62 exposed at the first end surface 51c is identical to the arrangement order of the plurality of optical waveguides 62 exposed at the second end surface 51d. In this case, the input to the optical waveguide component 5A and the output from the optical waveguide component 5A are identical. Thus, the positioning structure 65 and the optical waveguide 62 do not interfere with each other, and the compact optical waveguide component 5A having the identical input and output is provided. The optical waveguide component 5B also has the similar configuration as the optical waveguide component 5A in this respect, and the similar effect is exhibited.

In the optical waveguide component 5, the shortest distance between the optical waveguide 52 and the positioning structure 55 is less than 1 mm. In this case, a space for disposing the positioning structure 55 is maintained. Thus, a compact optical waveguide component provided with the positioning structure 55 is provided. The optical waveguide components 5A and 5B also have the similar configuration as the optical waveguide component 5 in this respect, and the similar effect is exhibited.

The optical waveguide component 5 has the pair of side surfaces 51e and 51f arranged in the X-axis direction. In the optical waveguide component 5, the positioning structure 55 has a shape in which the side surfaces 51e and 51f are recessed in the X-axis direction. The compact optical waveguide component 5 is provided that can be easily positioned. The optical waveguide components 5A and 5B also have the similar configuration as the optical waveguide component 5 in this respect, and the similar effect is exhibited.

The holding member 3 includes the engagement portion 31. The engagement portion 31 engages the positioning structures 55, 65, 75 of the optical waveguide components 5, 5A, and 5B. The holding member 3 is provided that has a compact configuration and more reliably positions the optical waveguide components 5, 5A, and 5B.

Although the embodiments of the present disclosure have been described in detail, the present disclosure is not limited to the above-described embodiments, and can be applied to various embodiments.

For example, the engagement portion 31 is not limited to the pair of protrusions 32. The engagement portion 31 may position the optical waveguide component 5 with respect to the silicon photonics chip by being inserted into a hole provided in the optical waveguide component 5 in the Z-axis direction, for example.

The positioning structures 55, 65, and 75 may be, for example, a hole formed in the surface S2 of the base members 51, 61, and 71. For example, the positioning structures 55, 65, 75 may be a hole formed in the side surface 51e of the base members 51, 61, and 71. For example, the positioning structures 55, 65, and 75 may be a hole formed in the main surface 51a of the base members 51, 61, and 71. The positioning structures 55, 65, and 75 may be, for example, a plurality of holes formed in one space S3.

What is claimed is:

1. An optical waveguide component comprising:
a base member; and
a plurality of optical waveguides extending in a first direction inside the base member and being arranged in a second direction intersecting the first direction,
wherein each of the plurality of optical waveguides has a pair of end portions,
wherein the base member includes a positioning structure configured to position the base member and has a surface at which the pairs of end portions are exposed,
wherein each of the plurality of optical waveguides includes a curved portion curved in the second direction, and
wherein the positioning structure is disposed at a position overlapping with the curved portions in the second direction.

2. The optical waveguide component according to claim 1,
wherein the surface includes a first end surface at which first end portions among the pairs of end portions of the plurality of optical waveguides are exposed and a second end surface at which second end portions among the pairs of end portions of the plurality of optical waveguides are exposed, the second end surface being located opposite to the first end surface in the first direction, and
wherein an arrangement order of the plurality of optical waveguides exposed at the first end surface is identical to an arrangement order of the plurality of optical waveguides exposed at the second end surface.

3. The optical waveguide component according to claim 1,
wherein a shortest distance between each of the optical waveguides and the positioning structure is less than 1 mm.

4. The optical waveguide component according to claim 1,
wherein the optical waveguide component has a pair of side surfaces arranged in the second direction, and
wherein the positioning structure has a shape in which at least one of the side surfaces is recessed in the second direction.

5. A holding member comprising:
an engagement portion configured to engage the positioning structure of the optical waveguide component according to claim 1.

6. A holding member comprising:
an engagement portion configured to engage the positioning structure of the optical waveguide component according to claim 2.

7. A holding member comprising:
an engagement portion configured to engage the positioning structure of the optical waveguide component according to claim 3.

8. A holding member comprising:
an engagement portion configured to engage the positioning structure of the optical waveguide component according to claim 4.

9. An optical connection member comprising:
the optical waveguide component according to claim 1;
a holding member including an engagement portion configured to engage the positioning structure of the optical waveguide component; and
a plurality of optical fibers connected to the optical waveguide component.

10. An optical connection member comprising:
the optical waveguide component according to claim 2;
a holding member including an engagement portion configured to engage the positioning structure of the optical waveguide component; and
a plurality of optical fibers connected to the optical waveguide component.

11. An optical connection member comprising:
the optical waveguide component according to claim 3;
a holding member including an engagement portion configured to engage the positioning structure of the optical waveguide component; and
a plurality of optical fibers connected to the optical waveguide component.

12. An optical connection member comprising:
the optical waveguide component according to claim 4;
a holding member including an engagement portion configured to engage the positioning structure of the optical waveguide component; and
a plurality of optical fibers connected to the optical waveguide component.
